(19) United States
(12) Patent Application Publication
(10) Pub. No.: US 2015/0360249 A1
(43) Pub. Date: Dec. 17, 2015

(54) METHOD FOR COATING METAL TUBE WITH ENAMEL AND ENAMEL COATING APPARATUS USED THEREFOR

(71) Applicant: U-JIN PORCELAIN ENAMEL LTD., Asan-si (KR)

(72) Inventor: Sang-Hee HUR, Asan-si (KR)

(21) Appl. No.: 14/302,875

(22) Filed: Jun. 12, 2014

(51) Int. Cl. B05B 13/02; B05D 1/28; B05D 3/00

(52) U.S. Cl. CPC B05B 13/0221; B05D 3/002; B05D 1/28

(57) ABSTRACT

Disclosed herein is a method for coating a metal tube with enamel. The method includes (a) feeding the metal tube, which moves forwards while being rotated by an in-feed conveyor, into a pretreatment chamber, thus pre-treating a surface of the metal tube, (b) feeding the metal tube, which has been pre-treated at (a), into a coating chamber, thus coating the surface of the metal tube with enamel glaze which is supplied from an enamel-glaze supply nozzle provided in the coating chamber, and (c) feeding the metal tube, which has been coated at (b), into a firing chamber, thus firing the metal tube at a temperature of 750 to 1000° C. At (c), the firing chamber includes a firing chamber conveyor having two or more hourglass-shaped rollers, and conveys the metal tube to an output conveyor while supporting a bottom of the metal tube heated by the hourglass-shaped roller.

### BACKGROUND OF THE INVENTION

1. Technical Field

The present invention relates generally to a method for coating a metal tube with enamel and an enamel coating apparatus used therefor. More particularly, this invention relates generally to a method for coating a fin tube with enamel and an enamel coating apparatus used therefor, the fin tube having a heat transfer fin on a surface of a metal tube.

2. Description of the Related Art

Since a metal tube is mainly used in a humid environment, various kinds of coating methods are performed on a surface of the metal tube to improve durability. As one of the coating methods, an enamel coating method is advantageous in that it has high heat resistance and high acid resistance, but is problematic in that a coating process is difficult, for example, firing at a high temperature (750 to 1000° C.) is required, so that the enamel coating method is not widely used.

Particularly, since a high-temperature firing process is required, a large-scale firing chamber should be provided to coat long and large volume objects with enamel glaze, thus making the process economically inefficient. Due to the aforementioned issues, it is considered almost impossible to coat a long and large volume object with enamel.

Meanwhile, if a metal tube used in a poor environment, such as a fin tube used as a heat exchanger for a power generator (as gas is cooled when heat exchange is performed using gas containing an acid component in the power generator, a tube surface and a heat transfer fin are exposed to an acid dew point, so that low-temperature corrosion occurs in a fin tube) is coated with general coating composition, the inevitably corroded metal tube should be periodically replaced with a new one, thus not only causing inconvenience but also incurring high cost. In order to solve the problems, a metal tube made of a material such as a stainless-based material or titanium may be used. However, in addition to not contributing to a fundamental solution, this causes an increase in cost and makes it necessary to more frequently replace the fin tube with a new one. Further, there has been proposed a method for applying Teflon coating to the fin tube. However, a Teflon material is limited in terms of heat resistance. Thus, it may be desirable to apply the enamel coating to the metal tube used in the poor environment, for example, an environment requiring heat resistance and acid resistance.

The reason why it is difficult to coat the surface of the metal tube with the enamel is as follows:

First, as described above, a high-temperature firing chamber is needed. Particularly, when the length of the metal tube is long, a high-temperature firing chamber of a large size is needed, thus making it more difficult to perform the enamel coating.

Second, when the metal tube undergoes the coating process during the high-temperature firing process, the metal tube may be undesirably bent or twisted in shape. In this regard, the longer the metal tube is, the more frequent the problem occurs. Therefore, there is required a method for preventing the metal tube from being deformed when the metal tube is coated.

Third, since oil components stained on the surface of the metal tube during a pretreatment process inhibit an aqueous enamel glaze from being bound to the surface of the metal tube, it is necessary to remote the oil components before enamel coating is performed. However, it is difficult to efficiently remove the oil components using conventional pretreatment methods.

That is, among the pretreatment processes, a blast process is ineffective in removing the oil components. In the case of introducing a wet process, the pretreatment becomes complicated, thus leading to a reduction in coating efficiency. Therefore, it is necessary to develop a method for conveniently removing the oil components from the surface of the metal tube.

Fourth, it is not easy to remove a bubble formed in a coating layer after the enamel glaze has been coated. Since the removal of the bubble formed in the coating layer determines a coating quality, the removal of the bubble is very important in the Fcoating process. Particularly, in the case of a fin tube (see FIGS. 10A to 10C) for a heat exchanger having a plurality of heat transfer fins formed on a surface of a metal tube, it is difficult to remove the bubble from the surface of the tube and the surface of each heat transfer fin. However, such a bubble should be thoroughly removed so as to obtain a fin tube having high durability. In the past, a method of tapping the metal tube so as to remove the bubble has been used. However, in the case of a long metal tube, it is difficult to use such a method and the method is poor in effect.

Consequently, in order to apply the enamel coating to the metal tube and then utilize the excellent physical properties of the enamel coating, the above-mentioned problems should be addressed in advance.

### SUMMARY OF THE INVENTION

Accordingly, the present invention has been made keeping in mind the above problems occurring in the prior art, and an object of the present invention is to provide an enamel coating method and an enamel coating apparatus, which are capable of preventing a long metal tube from being bent or twisted during a high-temperature firing process.

Another object of the present invention is to provide an enamel coating method and an enamel coating apparatus, which are capable of simplifying a process of coating a metal tube, in addition to realizing simple equipment.

In order to accomplish the above objects, the present invention provides a method for coating a metal tube with enamel, including (a) feeding the metal tube, which moves forwards while being rotated by an in-feed conveyor, into a pretreatment chamber, thus pre-treating a surface of the metal tube; (b) feeding the metal tube, which has been pre-treated at (a), into a coating chamber, thus coating the surface of the metal tube with enamel glaze which is supplied from an enamel-glaze supply nozzle provided in the coating chamber; and (c) feeding the metal tube, which has been coated at (b), into a firing chamber, thus firing the metal tube at a temperature of 750 to 1000° C., wherein, at (c), the firing chamber includes a firing chamber conveyor having two or more hourglass-shaped rollers, the firing chamber conveyor conveying the metal tube to an output conveyor while supporting a bottom of the metal tube heated by the hourglass-shaped roller.

Further, the present invention provides an apparatus for coating a metal tube with enamel, the apparatus having a coating unit including a pretreatment chamber configured to pre-treat a surface of the metal tube that is fed from an in-feed conveyor while being rotated; a coating chamber configured to coat the surface of the metal tube with enamel glaze that is supplied from an enamel-glaze supply nozzle provided therein, when the metal tube which has been pre-treated is fed into the coating chamber; and a firing chamber configured to fire the metal tube at a temperature of 750 to 1000° C., when the metal tube which has been coated is fed into the firing chamber, wherein the firing chamber includes a firing chamber conveyor configured to convey the metal tube to an output conveyor while supporting a bottom of the heated metal tube, the firing chamber conveyor including two or more hourglass-shaped rollers.

As is apparent from the above description, the enamel coating method of the present invention is advantageous in that it prevents the bending or twisting that often occurs in a long metal tube during a high-temperature firing process, thus affording an enamel-coated metal tube of excellent quality.

The enamel coating method of the present invention is advantageous in that it employs a firing chamber conveyor, so that it is possible to perform a firing process without connecting the metal tubes to each other unlike in a conventional method in which a rear end of a metal tube is connected to another metal tube before it is fed into a pretreatment chamber and the firing process is performed in such a connected state, thus simplifying the coating process and improving the productivity of an enamel-coated metal tube.

Further, the enamel coating method of the present invention is advantageous in that an hourglass-shaped roller substitutes for a pair of rotary rollers, thus realizing the simplification of a coating apparatus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an example of an enamel coating apparatus used for an enamel coating method of the present invention;

FIGS. 2A and 2B show the enamel coating apparatus used for the enamel coating method of the present invention, in which FIG. 2A shows an in-feed conveyor and FIG. 2B shows the configuration of a motor and a roller included in the in-feed conveyor;

FIG. 3 is a schematic sectional view showing a coating unit of the enamel coating apparatus used for the enamel coating method of the present invention;

FIG. 4 is a view schematically showing a configuration of an induction heater used in the enamel coating method of the present invention;

FIG. 5 is a photograph taken of a manufacturing process of the induction heater used in the enamel coating method of the present invention;

FIG. 6 is a photograph of a metal tube that is heated by the induction heater used in the enamel coating method of the present invention;

FIG. 7 is a view schematically showing a coating chamber (general tube coating) included in the coating unit of the enamel coating apparatus used for the enamel coating method of the present invention;

FIG. 8 is a view schematically showing a coating chamber (fin tube coating) included in the coating unit of the enamel coating apparatus used for the enamel coating method of the present invention;

FIG. 9 is a view schematically showing an air jet direction of an air jet nozzle used in the enamel coating method of the present invention;

FIGS. 10A to 10C are photographs taken of a fin tube coated by the enamel coating method of the present invention;

FIG. 11 is a view schematically showing the enamel coating apparatus adopting an hourglass-shaped roller used in the enamel coating method of the present invention;

FIG. 12 is a view schematically showing a pretreatment chamber conveyor 400, a coating chamber conveyor 500 and a firing chamber conveyor 600 of the enamel coating apparatus used for the enamel coating method of the present invention;

FIG. 13 is a perspective view showing an hourglass-shaped roller used in the enamel coating apparatus of the present invention; and

FIG. 14 is a perspective view showing an hourglass-shaped roller having a cooling-solvent circulating path 271, which is used in the enamel coating apparatus of the present invention.

### DESCRIPTION OF THE PREFERRED EMBODIMENTS

Reference now should be made to the drawings, throughout which the same reference numerals are used to designate the same or similar components.

Hereinafter, the preferred embodiment of the present invention will be described in detail with reference to the accompanying drawings. In the following description, if it is decided that the detailed description of known functions or configurations related to the invention makes the subject matter of the invention unclear, the detailed description is omitted.

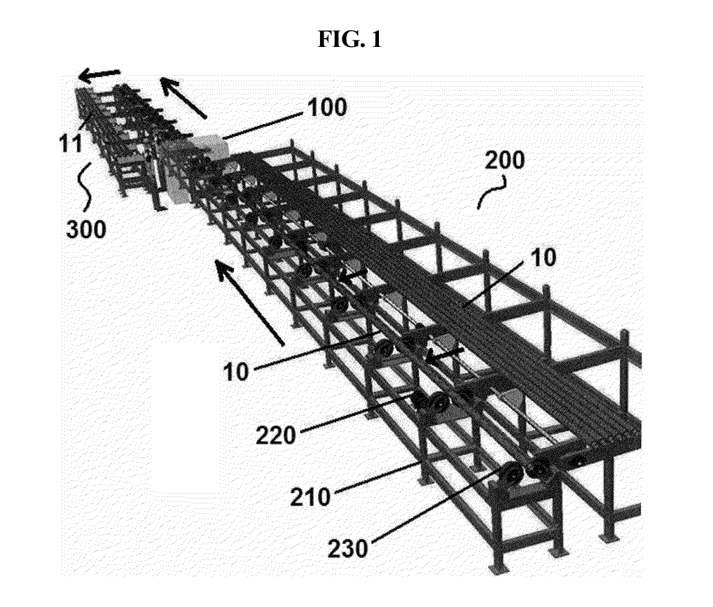

As shown in FIGS. 1 to 14, an enamel coating method of the present invention includes (a) feeding the metal tube 10, which moves forwards while being rotated by an in-feed conveyor 200, into a pretreatment chamber 110, thus pre-treating the surface of the metal tube 10, (b) feeding the metal tube 10, which has been pre-treated at (a), into a coating chamber 120, thus coating the surface of the metal tube 10 with enamel glaze which is supplied from an enamel-glaze supply nozzle 121 provided in the coating chamber 120, and (c) feeding the metal tube 10, which has been coated at (b), into a firing chamber 130, thus firing the metal tube 10 at a temperature of 750 to 1000° C.

At (c), the firing chamber 130 includes a firing chamber conveyor 600 having two or more hourglass-shaped rollers 270. The firing chamber conveyor 600 is configured to convey the metal tube 10 to an output conveyor 300 while supporting a bottom of the metal tube 10 heated by the hourglass-shaped roller 270.

In the enamel coating method of the present invention, each of the hourglass-shaped rollers 270 may be mounted on an axis that forms an angle of 5° to 35° clockwise or counterclockwise with respect to a transverse line that is perpendicular to a longitudinal line of the firing chamber conveyor 600. In this case, the firing chamber conveyor 600 may be configured to convey the metal tube 10 to the output conveyor 300 by rotating and moving forwards the metal tube 10 while supporting the bottom of the metal tube 10 heated by the hourglass-shaped roller 270.

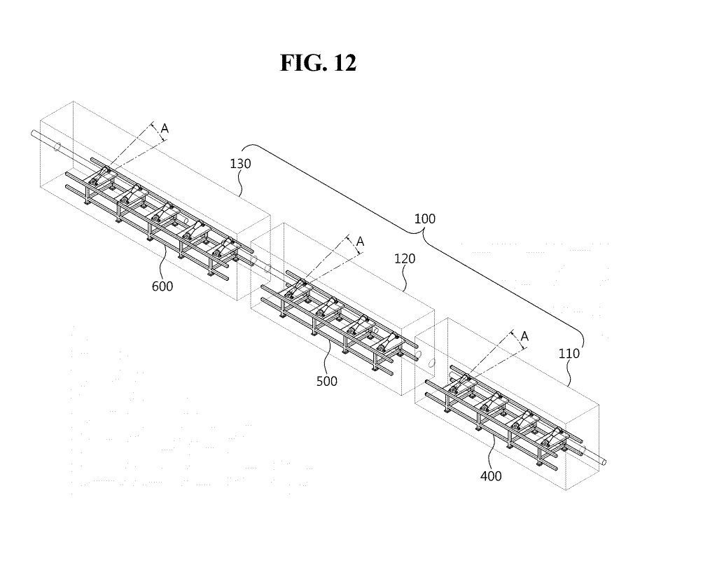

The enamel coating method of the present invention has the following features: as shown in FIG. 12, the firing chamber 130 is provided with the firing chamber conveyor 600 having the two or more hourglass-shaped rollers 270, and the firing chamber conveyor 600 is configured to convey the metal tube 10 to the output conveyor 300 while supporting the bottom of the metal tube 10 heated by the hourglass-shaped roller 270.

That is, at (c), the process of firing the metal tube is performed at the high temperature of 750 to 1000° C. Thus, if the metal tubes 10 are connected to each other and thus front and rear ends of each metal tube 10 are not supported, non-supported portions may be bent or twisted while the metal tube 10 is passing through the firing chamber 130. Hence, according to the related art, the rear end of the metal tube 10 is connected to another metal tube 10 before the metal tube 10 is fed into the pretreatment chamber 110. In such a state, a pretreatment process, a coating process, and a firing process are carried out.

However, if the rear end of the metal tube 10 is connected to the front end of another metal tube 10, labor for handling it is required. Further, even in the case where the metal tubes 10 are connected to each other and supported, if each metal tube 10 is heated at the high temperature of 750 to 1000° C. in the firing chamber 130, the metal tube 10 is often bent or twisted. Thus, in order to solve the problem, the present invention has been proposed.

As shown in FIG. 12, in order to more perfectly prevent the metal tube 10 from being bent or twisted in the firing process, the enamel coating method of the present invention further includes the firing chamber conveyor 600 that supports and moves the metal tube 10, thus supporting the high-temperature metal tube 10 passing through the firing chamber 130 and thereby preventing the metal tube 10 from being deformed.

As shown in FIG. 12, the firing chamber conveyor 600 may be configured to include two or more hourglass-shaped rollers 270. Each hourglass-shaped roller 270 is mounted on the axis that forms the angle of 5° to 35°, more preferably, 10° to 30° clockwise or counterclockwise with respect to the transverse line that is perpendicular to the longitudinal line of the firing chamber conveyor 600.

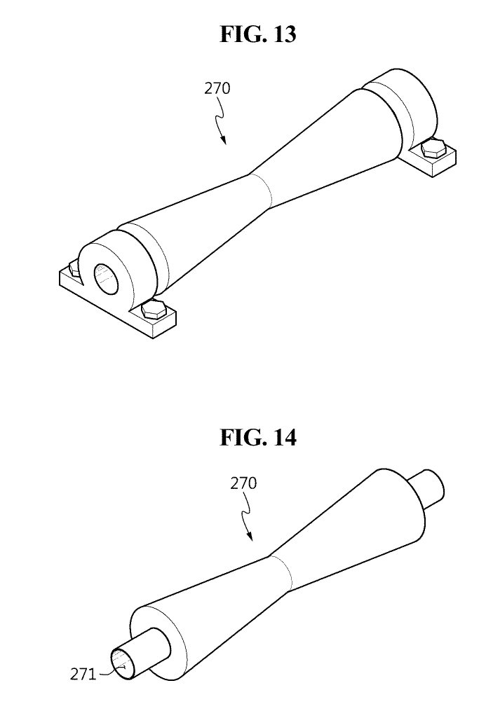

As shown in FIGS. 13 and 14, the hourglass-shaped roller 270 has a shape similar to that of an hourglass. When such an hourglass-shaped roller 270 is mounted on the axis that forms the angle of 5° to 30° clockwise or counterclockwise with respect to the transverse line that is perpendicular to the longitudinal line of the conveyor, and is rotated by power that is supplied directly or indirectly, it functions to rotate and advance the metal tube 10 that is resting on the roller 270. In this regard, an angle at which an axis of the hourglass-shaped roller 270 is tilted serves to determine the rotating speed of the metal tube 30. In the enamel coating method of the present invention, the rotating speed of the metal tube is for example 2 to 10 times per minute, preferably, 5 to 9 times. It is possible to adjust the angle at which the axis of the hourglass-shaped roller 270 is tilted, in consideration of rpm.

The configuration of the firing chamber conveyor 600 except the hourglass-shaped roller 270 may adopt a configuration that is commonly used in this field. The transmission of power to the hourglass-shaped roller 270 may be performed by a method that is commonly used in this field.

The hourglass-shaped roller 270 may be made of any material, as long as it withstands a temperature of 750 to 1000° C. A metal material may be preferably used.

As describe above, when the firing chamber conveyor 600 is provided in the firing chamber 130, the bending or twisting of the metal tube does not occur in the firing process even if the metal tubes 10 are not connected to each other, and it is possible to achieve the same effect even when the metal tubes 10 are connected to each other.

The metal tubes 10 may be automatically or manually connected to each other using various connecting members which are known to those skilled in the art.

Since the process of firing the metal tube 10 is performed at a high temperature, the firing chamber conveyor 600 provided in the firing chamber 130 should also have excellent heat resistance. Particularly the hourglass-shaped roller 270 comes into direct contact with the metal tube heated at the high temperature, so that it should have heat resistance. However, since a material having heat resistance sufficient to withstand the high temperature of 750 to 1000° C. is rare and expensive, the enamel coating method of the present invention is intended to cool the hourglass-shaped roller 270 with cooling solvent.

That is, in the enamel coating method of the present invention, the hourglass-shaped roller 270 included in the firing chamber conveyor 600, as shown in FIG. 14, may be provided with a cooling-solution circulating path 271 that passes through a rotating shaft. If cooling solution such as coolant circulates through the cooling-solution circulating path 271 formed as described above, the hourglass-shaped roller 270 may be reliably operated without causing any problem even at the firing temperature (i.e. 750 to 1000° C.) of the metal tube 10.

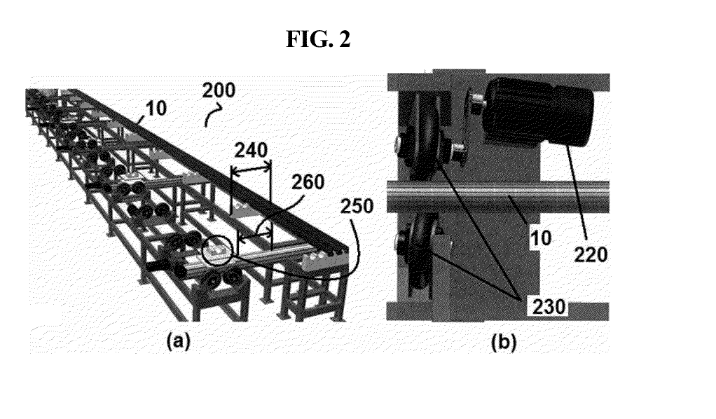

In the enamel coating method of the present invention, as shown in FIGS. 1 and 2 in detail, the continuous rotation and advance of the metal tube 10 may be carried out by motors 220 installed in an in-feed conveyor 200 and/or an out-feed conveyor 300 and several pairs of rotary rollers 230 forming alternate angles to rotate and advance the metal tube by power supplied from the motors 220.

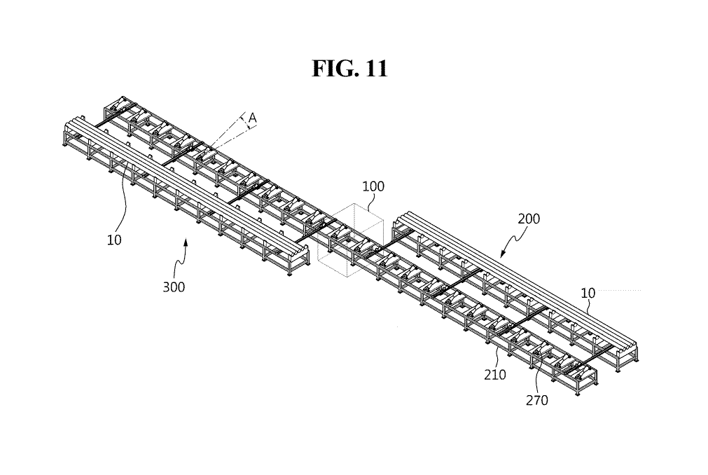

Further, as shown in FIGS. 11 and 12, the continuous rotation and advance of the metal tube 10 may be carried out by motors (not shown) installed in the in-feed conveyor 200 and/or the out-feed conveyor 300 and the hourglass-shaped rollers 270 configured to rotate and advance the metal tube by power supplied from the motors.

As shown in FIGS. 11 and 12, each hourglass-shaped roller 270 is mounted on the axis that forms the angle of 5° to 35°, more preferably, 10° to 30° clockwise or counterclockwise with respect to the transverse line that is perpendicular to the longitudinal line of the conveyor. As shown in FIGS. 13 and 14, the hourglass-shaped roller 270 has a shape similar to that of an hourglass. When such an hourglass-shaped roller 270 is mounted on the axis that forms the angle of 5° to 30° clockwise or counterclockwise with respect to the transverse line that is perpendicular to the longitudinal line of the conveyor, and is rotated by power that is supplied directly or indirectly, it functions to rotate and advance the metal tube 10 that is resting on the roller 270. In this regard, an angle at which the axis of the hourglass-shaped roller 270 is tilted serves to determine the rotating speed of the metal tube 30.

If the above-mentioned hourglass-shaped roller 270 is used in the conveyor, the roller is simplified, thus resulting in simplifying the entire apparatus.

In the enamel coating method of the present invention, the rotating speed of the metal tube is, for example, 2 to 10 times per minute, preferably, 5 to 9 times. It is possible to control the rotating speed of the metal tube by adjusting the alternating angles of the rotary roller 230 (see FIG. 2B) or by adjusting the angle at which the axis of the hourglass-shaped roller 270 (see FIG. 11) is tilted.

In the enamel coating method of the present invention, as shown in FIG. 1 and FIGS. 2A and 2B, if the in-feed conveyor 200 and the out-feed conveyor 300 are used and the pretreatment process, the coating process, and the firing process are performed in the state where the rear end of the metal tube 10 is connected to another metal tube 10 before the metal tube is fed into the pretreatment chamber 110, a separate pretreatment chamber conveyor 400 and a separate coating chamber conveyor 500 may not be required. That is, as in the present invention, if the coating unit 100 including the pretreatment chamber 110, the coating chamber 120 and the firing chamber 130 is compact and thereby its length is very short as compared to the length of the metal tube that is to be coated, the continuous rotation and advance of the metal tube 10 is possible by the in-feed conveyor 200 and the out-feed conveyor 300 positioned before and after the pretreatment chamber 110 and the coating chamber 120 even if they do not use separate conveyors.

Meanwhile, if each metal tube 10 is individually coated instead of performing the pretreatment process, the coating process, and the firing process in the state where the rear end of the metal tube 10 is connected to another metal tube 10 before it being fed into the pretreatment chamber 110, one or more of the pretreatment chamber conveyor 400, the coating chamber conveyor 500 and the firing chamber conveyor 600 may be required to allow the respective metal tubes 10 to have rotating and advancing force in the pretreatment process, the coating process, and the firing process.

The pretreatment process for the metal tube at step (a) may be carried out by methods that are widely used in this field, for example, shot blasting, sand blasting, grit blasting, etc.

Further, the metal tube may be pre-treated by wet pretreatment that is generally used in metal pretreatment. It is possible to adopt a method of generating ultrasonic waves in pretreatment solution during the wet pretreatment, thus more efficiently removing impurities from the surface of the metal tube.

However, oil components are not smoothly removed by the blast process, and the number of parts to be installed is increased and the pretreatment process is complicated in the case of introducing the wet process, so that coating efficiency is lowered. Thereby, it is difficult to apply the above-mentioned method to the automated enamel coating method as in the present invention.

Therefore, the enamel coating method of the present invention may adopt a method in which a heating means 111 is applied to the pretreatment chamber 110 to heat the metal tube 10 at the high temperature, thus burning the oil components and removing them from the surface within a short period of time.

The high-temperature heating process may be performed by the heating means 111 that is generally used. That is, the example of the heating means may include an electric furnace, a plasma heating furnace, a heavy oil furnace, a light oil furnace, a gas furnace, a hydrogen heating furnace, and an induction heating furnace.

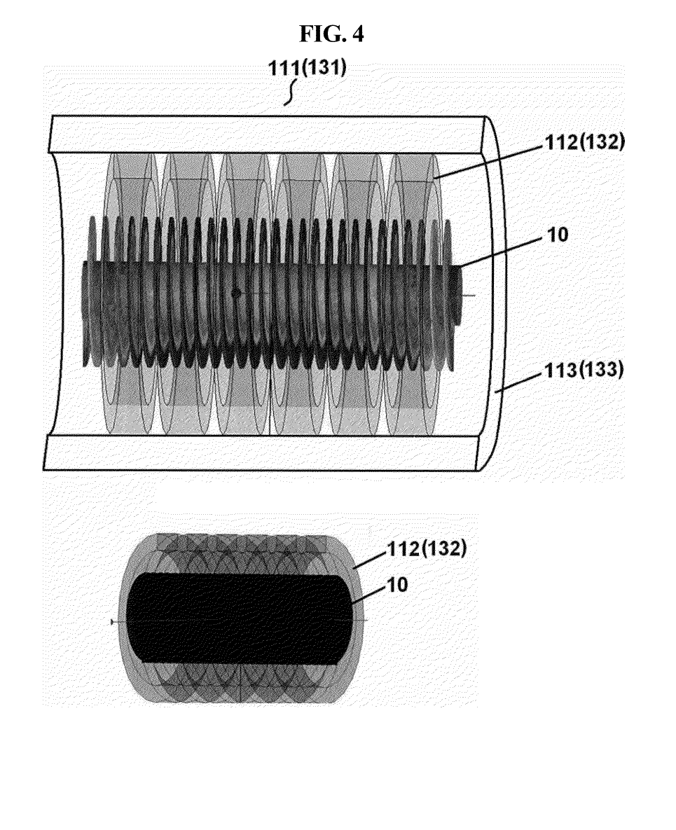

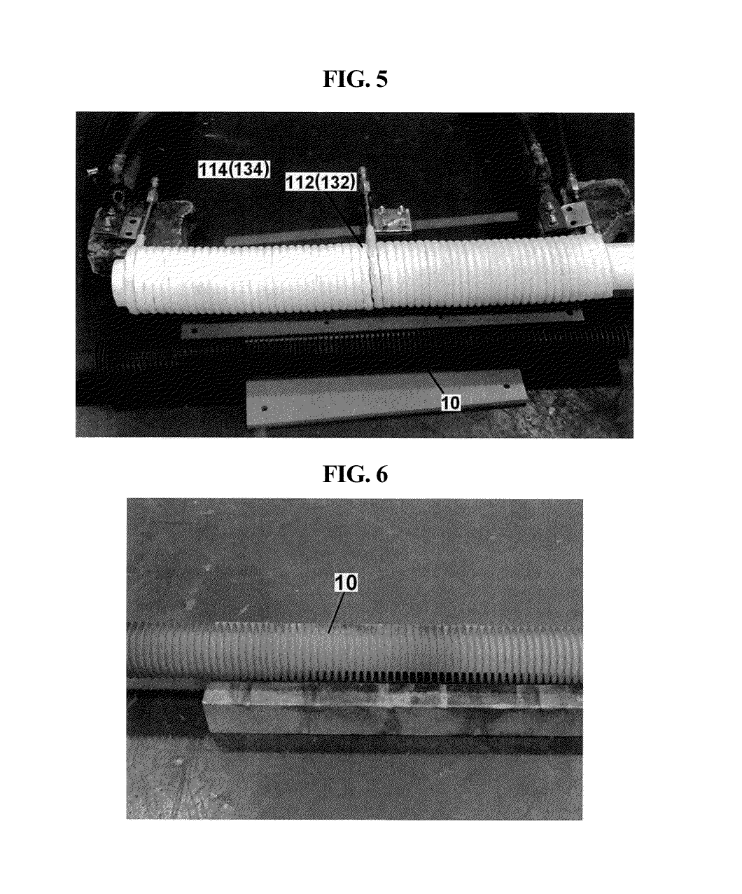

In the enamel coating method of the present invention, an induction heater 111 may be preferably used as the induction heating furnace illustrated in FIGS. 4 and 5. Among induction heaters, a high-frequency induction heater using a high-frequency current may be preferably employed.

In the enamel coating method of the present invention, since the in-feeding of the metal tube 10 is performed together with the rotation, the induction heater 111 may have any shape. That is, since the metal tube 10 can be evenly heated regardless of the shape of the induction heater 111, all shapes that are known in this field are possible.

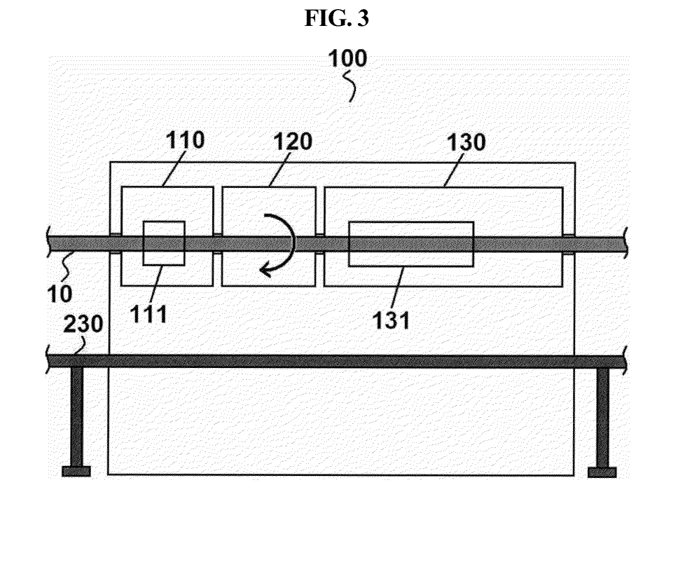

As shown in FIGS. 3 to 5, the induction heater 111 may preferably use a cylindrical or an arc-shaped (not shown) induction heater having a curvature radius that is 5 mm to 150 mm larger than an outside diameter of the metal tube 10. The induction heater may be provided in the moving direction of the metal tube 10 in such a way that an outer surface of the moving metal tube 10 and an inner curved surface of the cylindrical induction heater maintain a predetermined distance therebetween.

The high-temperature heat treatment is preferably performed in the pretreatment process at the temperature of 300 to 600° C., more preferably 400 to 500° C. for 10 seconds to 4 minutes, even more preferably 10 seconds to 2 minutes. If the high-temperature heat treatment is performed at the temperature less than 300° C., it takes a long time to remove the oil components. On the contrary, if the high-temperature heat treatment is performed at the temperature more than 500° C., the economic efficiency is lowered. Further, if the high-temperature heat treatment is performed for a period less than 10 seconds, it is difficult to reach a required high temperature. On the contrary, if the high-temperature heat treatment is performed for a period of 5 minutes or more, it may cause a reduction in productivity. The metal tube that the high-temperature heat treatment is completed in the pretreatment process is cooled at 60° C. or less than to feed into the coating chamber.

When the high-temperature heat treatment is performed using the induction heater 111, it is possible to heat the metal tube 10 at the heat treatment temperature (i.e. 300 to 600° C.) within about one minute, so that it is easy to achieve the compactness of the pretreatment chamber 110, and the pretreatment cost is significantly reduced.

Further, the induction heater 111 may be easily manufactured in a small size to match the metal tube 10 having a small diameter, as compared to the conventional heating means, and besides, may perform a heating operation at a distance proximate to the metal tube 10, so that energy efficiency is excellent.

As shown in FIG. 4, the induction heater 111 may include a heating coil 112 formed in the shape of a circular tunnel, and an AC power source 114 (see FIG. 5) configured to supply a current to the heating coil 112. An insulation cover 113 may be optionally provided outside the heating coil 112.

As shown in FIG. 4, if the metal tube 10 is inserted into the circular tunnel formed by the heating coil 112 and an AC current is supplied, electric resistance occurs due to an eddy current on the surface of the metal tube 10, and thereby heat is generated on the surface of the metal tube 10.

FIG. 5 is photograph image of a manufacturing process of the induction heater 111. As shown in FIG. 5, the induction heater 111 is configured such that the heating coil 112 is formed in the shape of the circular tunnel, thus supplying the AC power.

FIG. 6 is a photograph taking the metal tube 10 that is heated by the induction heater 111 manufactured by the process of FIG. 5. It can be seen from FIG. 6 that the entire tube is heated red hot.

According to the test of FIGS. 5 and 6, when 18 seconds passed after the heating operation started, the surface temperature of the metal tube 10 reached 400° C. When 56 seconds passed, the surface temperature reached 680° C. Hence, the induction heater 111 enables the high-temperature pretreatment for the metal tube 10 to be completed within about one minute.

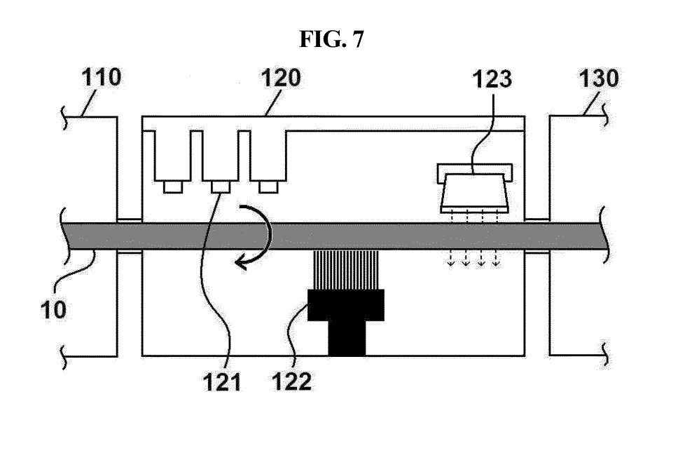

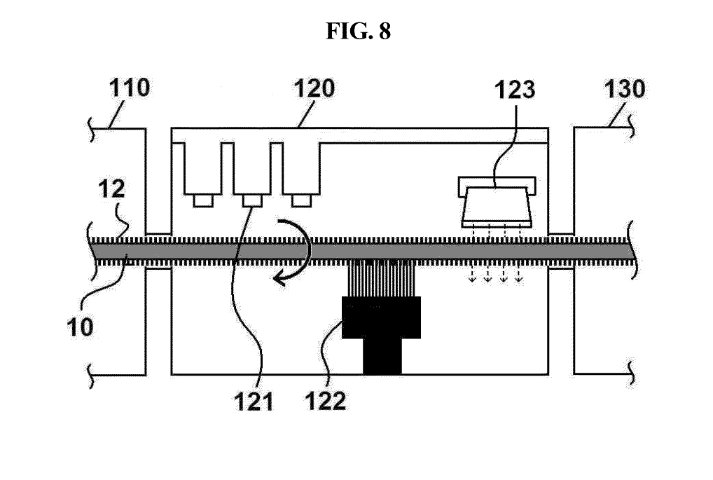

At step (b), the coating process of the metal tube is performed as follows as shown in FIGS. 7 and 8: the metal tube 10 which moves forwards while rotating is fed into the coating chamber 120, so that the surface of the metal tube 10 is coated with the enamel glaze supplied from the enamel-glaze supply nozzle 121 installed in the coating chamber, or in addition to this method, a coating brush 122 installed behind the enamel-glaze supply nozzle 121 is brought into contact with the surface of the metal tube 10 which moves forwards while rotating, so that excess enamel glaze applied to the surface of the metal tube 10 is removed and simultaneously bubbles are removed from the coating.

Further, an air jet device 123 is installed behind the enamel-glaze supply nozzle 121, so that it jets the air onto the surface of the metal tube 10 which moves forwards while rotating, at the speed of 0.05 m/s to 3 m/s, more preferably 0.1 m/s to 1.5 m/s, thus removing the excess enamel glaze from the surface of the metal tube 10 and simultaneously removing the bubbles from the coating.

If the air jet speed is less than 0.05 m/s, it is difficult to expect the air jet effect. On the other hand, if the air jet speed is more than 3 m/s, the applied enamel glaze may be excessively removed.

When the air jet process is performed by the enamel-glaze supply nozzle 121 as such, the excess enamel glaze may be easily removed from the surface of the metal tube, the bubble may be efficiently removed from the coating layer, and the enamel glaze applied to the surface of the metal tube is primarily dried at step prior to the firing process, so that the enamel glaze is solidified while falling in a gravity direction in the firing process, thus preventing an uneven coating surface from being formed.

Further, bubbles are efficiently removed from the surface of the metal tube in the enamel-glaze coating process, so that it is possible to form a uniform and robust coating layer. Particularly, when the metal tube (e.g., metal fin tube) having an uneven surface is coated, it very easy to remove bubbles which are formed in every portion, such bubbles not being easily removed by an existing method.

The air jetted from the air jet nozzle 123 may be more preferably hot air of 30 to 200° C. In the case of jetting the hot air as such, the bubble may be more effectively removed, and the enamel glaze coated on the metal tube 10 before it enters the firing chamber 13 may be more effectively dried.

Further, the air jet nozzle 123 may be installed behind the coating brush 122 which is positioned behind the enamel-glaze supply nozzle 121. In this case, the enamel glaze may be uniformly applied to the surface of the metal tube, and the bubbles may be more perfectly removed.

As shown in FIG. 7, a required number of enamel-glaze supply nozzles 121 may be installed above the fed metal tube 10 in the progress direction thereof. However, this is only one example embodiment, and various kinds of enamel-glaze supply nozzles 121 may be freely installed at various places. If the enamel glaze flows out from or is jetted from each enamel-glaze supply nozzle 121 installed as such, the enamel glaze is uniformly applied to the metal tube 11 which moves forwards while rotating.

A place where the coating brush 122 is installed is not limited, as long as it is behind the enamel-glaze supply nozzle 121 when viewed in the progress direction of the metal tube 10. Further, any shape of brush is possible as long as it may remove the excess enamel glaze applied to the metal tube 10 and remove bubbles from the coating. If the metal tube 10 is the fin tube 10 having the heat transfer fins 12 on the surface thereof, the brush should be composed of staple fiber having proper strength and fineness to allow the enamel glaze to be uniformly coated on every portion of the heat transfer fins 12.

A place where the air jet nozzle 123 is installed is not limited, as long as it is behind the enamel-glaze supply nozzle 121 when viewed in the progress direction of the metal tube 10. Further, any shape of nozzle is possible, as long as it may remove the excess enamel glaze applied to the metal tube 10 and besides remove the bubbles from the coating.

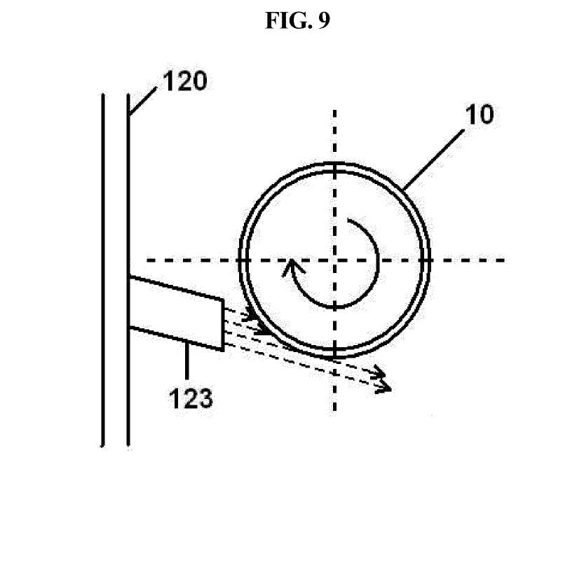

Particularly, as shown in FIG. 9, the air jet nozzle 123 preferably jets the air in a direction opposite the rotating direction of the metal tube 10 from side of the metal tube 10. Further, the air jet nozzle 123 is preferably installed to allow the jetted air to reach the lowermost end of the metal tube 10.

As such, when the jetted air reaches the lowermost end of the metal tube 10 which moves forwards while rotating, the excess enamel glaze applied to the surface of the metal tube 10 may be easily gathered in the lower end of the tube 10 by the jetted air, and may easily fall down by gravity, thus ensuring the easy removal of the excess enamel glaze. Further, the jetting of the air in the direction opposite the rotating direction of the metal tube 10 may more efficiently achieve the above objects, as compared to the jetting of the air in the same direction as the rotating direction of the metal tube 10.

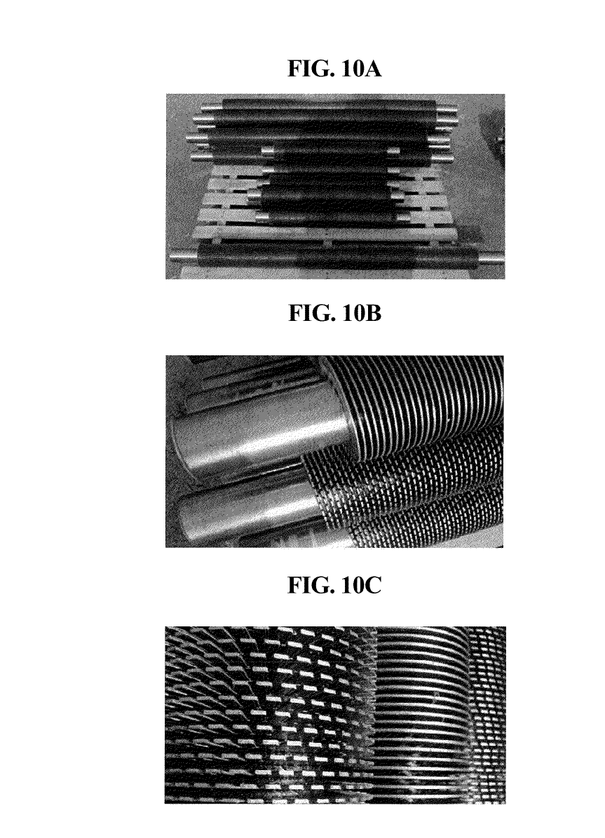

Since the enamel coating method of the present invention has the coating brush 122 and/or the air jet nozzle 123 configured as described above, it affords excellent effect even when a metal tube having a complicated surface shape is coated, like the fin tube 10 (see FIGS. 10A to 10C) for the heat exchanger having the heat transfer fins 12 on the surface of the tube.

At (c), the high-temperature firing process for the metal tube is performed at 750 to 1000° C., more preferably, 750 to 870° C. Thus, the firing chamber 130 is provided with the heating means. The heating means may use any heating means that is commonly used in this field, and the example of the heating means may include an electric furnace, a plasma heating furnace, a heavy oil furnace, a light oil furnace, a gas furnace, a hydrogen heating furnace, and an induction heating furnace.

In the present invention, the induction heating furnace may be preferably used as the heating means. The induction heating furnace may preferably use the induction heater 131 as shown in FIG. 3. The induction heater 111 may be easily manufactured in a small size to match the metal tube 10 having a small diameter, as compared to the conventional heating means, and besides, may perform a heating operation at a distance proximate to the metal tube 10, so that energy efficiency is excellent.

Particularly, since the metal tube 10 is heated by an induction heating method, heat is generated only on the surface of the metal tube 10 that is a conductor. Thus, the metal tube is first heated, and then the enamel glaze applied to the surface of the metal tube is heated by the heat, so that the enamel glaze is more uniformly and firmly bonded to the surface of the metal tube 10. Further, a defective coating is minimized.

By contrast, in the case of using the conventional heating means, heat is transferred through the enamel glaze applied to the external appearance of the metal tube 10 to the metal tube 10. Hence, the enamel glaze is first heated before the metal tube 10 is heated, so that the enamel glaze may flow down in the gravity direction and thereby the defective coating is likely to occur, and besides, it is lower in robustness of the coating than the induction heating method.

In the enamel coating method of the present invention, the metal tube 10 is fed into an associated chamber while rotating, so that the shape of the induction heater 131 is not important. That is, since the metal tube 10 may be evenly heated regardless of the shape of the induction heater 131, it may have any shape which is known in this field.

As shown in FIGS. 3 to 5, the induction heater 131 may preferably use a cylindrical or an arc-shaped (not shown) induction heater having a curvature radius that is 5 mm to 150 mm larger than an outside diameter of the metal tube 10. The induction heater may be provided in the moving direction of the metal tube 10 in such a way that an outer surface of the moving metal tube 10 and an inner curved surface of the cylindrical induction heater maintain a predetermined distance therebetween.

The induction heater 131 may include a heating coil 132 formed in the shape of a circular tunnel, and an AC power source 134 (see FIG. 5) configured to supply a current to the heating coil 132. An insulation cover 133 may be optionally provided outside the heating coil 132.

As shown in FIG. 4, if the metal tube 10 is inserted into the circular tunnel formed by the heating coil 132 and an AC current is supplied, electric resistance occurs due to an eddy current on the surface of the metal tube 10, and thereby heat is generated on the surface of the metal tube 10.

FIG. 5 is an image photographing the manufacturing process of the induction heater 111. As shown in FIG. 5, the induction heater 131 is configured such that the heating coil 132 is formed in the shape of the circular tunnel, thus supplying the AC power.

FIG. 6 is a photograph taken of the metal tube 10 that is heated by the induction heater 131 manufactured by the process of FIG. 5. It can be seen from FIG. 6 that the entire tube is heated red hot.

According to the test of FIGS. 5 and 6, when 1 minute 11 seconds have passed after the heating operation is started, the surface temperature of the metal tube 10 reached 800° C. Hence, the induction heater 131 enables the firing of the metal tube 10 to be completed within about 2 minutes.

In the enamel coating method of the present invention, the induction heater 131 may preferably employ a high-frequency induction heater that uses a high-frequency current.

For the purpose of coating the metal tube with the enamel, as for the related art, a firing chamber capable of accommodating the metal tube therein is needed, but as for the enamel coating apparatus of the present invention, even the long metal tube may be easily coated with the enamel in the coating unit including the compact firing chamber. Thus, the enamel coating method of the present invention is advantageous in that it is more economic than the related art when the metal tube has the length of 5 m or more. For example, assuming that the fin tube for the heat exchanger used in a power generator has the length of 18m, according to the conventional method, the firing chamber having a space of 18 m or more is required to perform the coating process, so that it is uneconomical in terms of energy efficiency and space utilization, whereas, according to the present invention, it is possible to easily and economically perform the firing process in the compacted firing chamber (its whole length is about 4 m or less).

Further, as shown in FIGS. 1 to 14, the present invention relates to an apparatus for coating a metal tube with enamel.

The enamel coating apparatus of the present invention includes a coating unit 100. The coating unit 100 includes a pretreatment chamber 110 that is configured to pre-treat a surface of the metal tube 10 that is fed from an in-feed conveyor 200 while being rotated, a coating chamber 120 that is configured to coat the surface of the metal tube 10 with enamel glaze that is supplied from an enamel-glaze supply nozzle 121 provided therein, if the metal tube 10 which has been pre-treated is fed into the coating chamber, and a firing chamber 130 that is configured to fire the metal tube at the temperature of 750 to 1000° C., if the metal tube which has been coated is fed into the firing chamber.

The firing chamber 130 includes a firing chamber conveyor 600 that is configured to convey the metal tube to an output conveyor 300 while supporting the bottom of the heated metal tube 10. The firing chamber conveyor 600 includes two or more hourglass-shaped rollers 270.

Since all technical features of the enamel coating method may be applied to the enamel coating apparatus, a duplicated description of the features will be omitted herein.

The hourglass-shaped roller included in the firing chamber conveyor may be mounted on the axis that forms the angle of 5° to 35° clockwise or counterclockwise with respect to a transverse line that is perpendicular to a longitudinal line of the firing chamber conveyor.

The whole length of the coating unit 100 in a feeding direction of the metal tube is preferably 5 m or less.

In the enamel coating apparatus, the whole length of the pretreatment chamber 110 of the coating unit 100 in the feeding direction of the metal tube 10 is 3 m or less, preferably 1 m or less, and the whole length of the coating chamber 120 is 2 m or less, preferably 1 m or less, and the whole length of the firing chamber 130 is 7 m or less, preferably 5 m or less. This preferably realizes the compactness of the coating unit 100.

The enamel coating apparatus of the present invention may further include an in-feed conveyor 200 configured to rotate and advance the metal tube 10, thus feeding the metal tube 10 into the pretreatment chamber 110, and an out-feed conveyor 300 configured to pull out the metal tube, which has been coated, out from the firing chamber.

As shown in FIG. 2A, the in-feed conveyor 200 includes a metal-tube stacking section 240, a metal-tube loading section 250, and a metal-tube transfer section 260 configured to transfer the metal tube from the stacking section to the loading section. The metal-tube transfer section 260 transfers several metal tubes from the stacking section 240 to the loading section 250 at an interval of predetermined time, thus allowing the metal tubes 10 to be continuously supplied to the coating unit 100.

Such a configuration may be likewise applied to the out-feed conveyor 300. In the out-feed conveyor 300, the metal tube 11 which has been coated is transferred from the metal-tube loading section 250 to the metal-tube stacking section 240.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for coating a metal tube with enamel, comprising:
(a) feeding the metal tube, which moves forwards while being rotated by an in-feed conveyor, into a pretreatment chamber, thus pre-treating a surface of the metal tube;
(b) feeding the metal tube, which has been pre-treated at (a), into a coating chamber, thus coating the surface of the metal tube with enamel glaze which is supplied from an enamel-glaze supply nozzle provided in the coating chamber; and
(c) feeding the metal tube, which has been coated at (b), into a firing chamber, thus firing the metal tube at a temperature of 750 to 1000° C.,
wherein, at (c), the firing chamber comprises a firing chamber conveyor having two or more hourglass-shaped rollers, and each of the hourglass-shaped rollers is mounted on an axis that forms an angle of 5° to 35° clockwise or counterclockwise with respect to a transverse line that is perpendicular to a longitudinal line of the firing chamber conveyor, and the firing chamber conveyor is configured to convey the metal tube to the output conveyor by rotating and moving forwards the metal tube while supporting the bottom of the metal tube heated by the hourglass-shaped roller.

2. The method as set forth in claim 1, wherein the hourglass-shaped roller comprises a cooling-solution circulating path that passes through a rotating shaft, and the (c) further comprises circulating cooling solution through the cooling-solution circulating path.

3. The method as set forth in claim 1, wherein, at (b), an air jet device is further installed behind the enamel-glaze supply nozzle, so that it jets the air onto the surface of the metal tube at the speed of 0.05 m/s to 3 m/s.

4. The method as set forth in claim 3, wherein the air jetted from the air jet nozzle is hot air of 30 to 200° C.

5. The method as set forth in claim 3, wherein the air jet nozzle jets the air in a direction opposite the rotating direction of the metal tube from side of the metal tube and to allow the air to reach the lowermost end of the metal tube.

6. The method as set forth in claim 3, wherein, at (a), the pretreatment chamber is provided with a heating means, high-temperature heat treatment of the metal tube being performed at the temperature of 300 to 600° C. for 10 seconds to 4 minutes as a pretreatment process.

7. The method as set forth in claim 6, wherein, at (c), the firing chamber is provided with an induction heating furnace as a heating means.

8. The method as set forth in claim 7, wherein the induction heating furnace is a cylindrical or an arc-shaped induction heater having a curvature radius that is 5 mm to 150 mm larger than an outside diameter of the metal tub, being provided in the moving direction of the metal tube in such a way that an outer surface of the moving metal tube and an inner curved surface of the cylindrical induction heater maintain a predetermined distance therebetween.

9. The method as set forth in claim 1, wherein the metal tube is a fin tube for a heat exchanger having a heat transfer fin formed on a surface of the tube.

10. An apparatus for coating a metal tube with enamel, the apparatus having a coating unit comprising a pretreatment chamber configured to pre-treat a surface of the metal tube that is fed from an in-feed conveyor while being rotated; a coating chamber configured to coat the surface of the metal tube with enamel glaze that is supplied from an enamel-glaze supply nozzle provided therein, when the metal tube which has been pre-treated is fed into the coating chamber; and a firing chamber configured to fire the metal tube at a temperature of 750 to 1000° C. when the metal tube which has been coated is fed into the firing chamber,
wherein the firing chamber comprises a firing chamber conveyor having two or more hourglass-shaped rollers, and each of the hourglass-shaped rollers is mounted on an axis that forms an angle of 5° to 35° clockwise or counterclockwise with respect to a transverse line that is perpendicular to a longitudinal line of the firing chamber conveyor, and the firing chamber conveyor is configured to convey the metal tube to the output conveyor by rotating and moving forwards the metal tube while supporting the bottom of the metal tube heated by the hourglass-shaped roller.
